(19) United States
(12) Patent Application Publication
(10) Pub. No.: US 2010/0000891 A1
(43) Pub. Date: Jan. 7, 2010

(54) PAPER BOARD PACKAGES FOR MEDIA DISCS

(75) Inventors: Charles E. Woodhead, Los Angeles, CA (US); Mark Preece, Valencia, CA (US)

Correspondence Address: MEADWESTVACO CORPORATION;ATTN: IP LEGAL DEPARTMENT, 1021 MAIN CAMPUS DRIVE, RALEIGH, NC, 27606, US

(73) Assignee: MeadWestvaco Corporation, Glen Allen, VA (US)

(21) Appl. No.: 12/496,870

(22) Filed: Jul. 2, 2009

Related U.S. Application Data
(60) Provisional application No. 61/078,672, filed on Jul. 7, 2008.
(60) Provisional application No. 61/078,689, filed on Jul. 7, 2008.

(51) Int. Cl. G11B 33/02

(52) U.S. Cl. 206/308.1

(57) ABSTRACT

A package for housing an item is provided, including a rectangular enclosure having an access opening in which to receive one or more items such as media discs, and a wrapper at least partly surrounding said items and closely fitting into said access opening.

### REFERENCE TO RELATED APPLICATION

This application claims the benefit of priority under 35 U.S.C. §119(e) of provisional application Ser. Nos. 61/078,672 and 61/078,689, both filed on Jul. 7, 2008, both of which are hereby incorporated by reference in their entireties

### BACKGROUND OF THE INVENTION

1. Field of the Invention

The present invention relates generally to a storage package for recording media and, more particularly, to a package comprising a paper board assembly for storing one or more discs.

2. Description of the Prior Art

Various types of planar discs are in use at the present time to record and store information which is to be retrieved by various means, such as by optical or magnetic means. Typical of such discs are compact discs in which information is digitally recorded by use of a laser beam and then read optically by a laser beam. Such discs are used to record audio information, such as musical renditions, video information such as visual images and digital information for use as read only and other memories for use in various applications, such as computer applications. In most instances, at the present time, such discs are sold with information already recorded thereon. In other applications, such discs are sold in blank form and are used by the customer to record information thereon. In the latter case, for example, optical discs are sold for use as computer storage media and are used in hard disc storage systems. As used herein, the terms media disc, compact disc, CD or disc are intended to encompass all such discs, whatever their size, for all known or proposed uses.

Compact discs containing laser recorded information are typically packaged in injection molded plastic enclosures designed to hold one or more CDs for protecting the discs during storage and shipment. Enclosures commonly used at the present time, such as the well known “jewel box,” comprise a three piece assembly consisting of a base or bottom element, an insert or tray in the base/bottom element for positioning and supporting the disc in the base/bottom element, e.g., by a center projection (commonly referred to as a “rosette”) which engages the periphery of the aperture in the center of the disc, and a lid or cover which is hinged to the base/bottom element and is closed thereon after the disc is mounted therein on the tray. Other enclosures utilize only two pieces, omit the tray, and position and support the disc via the center projection directly on the base/bottom element. The enclosure is, typically, at least partially transparent and graphics relating to the disc and containing trademark and sales promotional information are usually inserted in such a manner as to be visible through the enclosure.

Except for the printed matter inserted therein, the “jewel box” is entirely plastic. For this reason, as well as because the typical jewel box requires three separately injection molded elements which must be manually assembled, the use of this type of enclosure is relatively expensive. Moreover, the use of such an enclosure is believed to be ecologically unacceptable by many because the plastic is non-biodegradable and, in view of the huge volume of such enclosures in use today, the disposal of these enclosures poses either a real or potential environmental problem. One solution to both of these problems has been the development of hybrid packages comprising both paperboard and plastic components. These hybrid packages provide a CD package which is suitable and attractive for display, sale and storage of compact discs, yet which is both simple and inexpensive to manufacture.

For example, U.S. Pat. No. 4,709,812 to Kosterka, which is incorporated herein by reference, discloses a compact disc package formed from a pre-scored, preprinted unitary blank and at least one injection molded plastic compact disc holder or tray adhesively adhered to one segment of the blank, the blank being adapted to fold along fold lines to position a blank segment over the top of the disc holder to sandwich it, in book style, between the segment to which it is adhered and the overlying segment. The problem with this type of arrangement is that the book frequently opens and provides little protection for the disc there within.

It should be apparent, therefore, that efforts to date directed at hybrid packaging containing multiple discs suffer from one or more shortcomings which make the resulting CD packaging unsatisfactory. Among these shortcomings are that prior art hybrid packaging is typically either uneconomical to manufacture and may be expensive to transport, store and display in retail stores. Further, the plastic materials are not ecologically friendly. Accordingly, there remains a need for a simple, environmentally friendly, inexpensive to manufacture CD package that adequately protects the disc yet provides easy access thereto.

### SUMMARY

It is an object of the subject disclosure to provide a package for holding discs that is easy to manufacture from paper board or similar suitable environmentally friendly and/or recyclable material and adhesive such that promotional graphics and other necessary information like UPC codes can be printed directly on the package blank.

In one embodiment, the present disclosure is directed to a package for housing a disc including an enclosure with an elongated panel having an access opening through which one or more discs may be received into or removed from the package. The package may have internal supports or abutments to securely receive the one or more discs. The discs may be wrapped in a fold-around wrapper or “taco” together and graphics may be printed on the taco and extend onto the spine of the taco, where they may form a contiguous portion of additional graphics printed on the outside of the enclosure. Variations of the illustrative embodiment, including variations in the size and shape of the taco, variations in the size and shape of the access opening, and variations in the size and shape of the internal supports or abutments, are also within the contemplation of the present invention and are further described below. In certain embodiments the enclosure may be made from a single blank of material. In certain embodiments the enclosure may be made from more than one blank of material. In certain embodiments items other than discs may be housed within the package.

In another embodiment, the present disclosure is directed to a booklet-style package for housing a disc, including a hinged cover over an enclosure in which one or more discs may be received. The package may have internal supports or abutments for strength and to more securely receive the one or more discs. Graphics may be printed on all exterior surfaces (and at least some interior surfaces) and may extend onto all four spines of the package. Variations of the illustrative embodiment, including variations in the size and shape of the internal supports or abutments, are also within the contemplation of the present invention and are further described below. In certain embodiments the enclosure may be made from a single blank of material. In certain embodiments the enclosure may be made from more than one blank of material. In certain embodiments items other than discs may be housed within the package.

It should be appreciated that the present invention can be implemented and utilized in numerous ways, including without limitation as a process, an apparatus, a system, a device, and a method for applications and from other suitable materials now known and later developed. These and other unique features of the system disclosed herein will become more readily apparent from the following description and the accompanying drawings.

### BRIEF DESCRIPTION OF THE DRAWINGS

So that those having ordinary skill in the art to which the disclosed system appertains will more readily understand how to make and use the same, reference may be had to the following drawings.

FIG. 1 is a view of a blank for forming a package enclosure;

FIG. 2 is a perspective view of the blank of FIG. 1;

FIG. 3 is a perspective view of a step in the fabrication of a package enclosure from the blank of FIG. 2;

FIG. 4 is a perspective view of a further step in the fabrication of a package enclosure from the blank of FIG. 2;

FIG. 5A is a perspective view of a another step in the fabrication of a package enclosure from the blank of FIG. 2;

FIG. 5B is a perspective view of a final step in the fabrication of a package enclosure from the blank of FIG. 2;

FIG. 6A and 6B are perspective views of the finished package enclosure made from the blank of FIG. 2;

FIG. 7A is a view of a blank for forming a wrapper;

FIG. 7B is a perspective view of the wrapper blank of FIG. 7A;

FIG. 8A is a perspective view of a step in the folding of the wrapper, showing items to be held by the wrapper;

FIG. 8B is a perspective view of the folded wrapper, showing items held by the wrapper;

FIG. 9A is a perspective view of the folded wrapper, partly inserted into the package enclosure;

FIG. 9B is a perspective view of the folded wrapper, further inserted into the package enclosure;

FIG. 10A is a perspective view of the folded wrapper, entirely inserted into the package enclosure;

FIG. 10B is a perspective view of two folded wrappers partly inserted into the package enclosure;

FIG. 11 is a view of a blank for forming a package;

FIG. 12 is a perspective view of the blank of FIG. 11;

FIGS. 13-16 are perspective views of steps in the fabrication of a package from the blank of FIG. 12;

FIG. 17 is a perspective view of a finished package made from the blank of FIG. 12;

FIG. 18 is a perspective view of the finished package holding items therein; and

FIG. 19 is a perspective view of the closed package.

### DESCRIPTION OF EXEMPLARY EMBODIMENTS

The present invention overcomes many of the prior art problems associated with CD packages. The advantages, and other features of the package disclosed herein, will become more readily apparent to those having ordinary skill in the art from the following detailed description of certain preferred embodiments taken in conjunction with the drawings which set forth representative embodiments of the present invention and wherein like reference numerals identify similar structural elements whenever possible.

All relative descriptions herein such as left, right, up, down, topside, underside and the like are with reference to the Figures, and not meant in a limiting sense. The illustrated embodiments can be understood as providing exemplary features of varying detail of certain embodiments, and therefore, unless otherwise specified, features, components, modules, elements, and/or aspects of the illustrations can be otherwise combined, interconnected, sequenced, separated, interchanged, positioned, and/or rearranged without materially departing from the disclosed systems or methods. Additionally, the shapes and sizes of components are also exemplary and unless otherwise specified, can be altered without materially affecting or limiting the disclosed technology to holding discs exclusively.

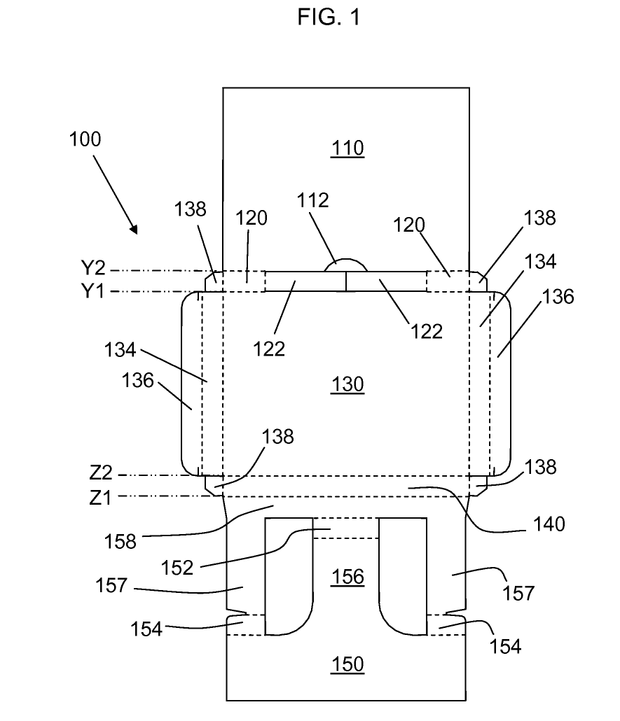

FIG. 1 shows a package blank 100 for forming an exemplary package enclosure 102. Package blank 100 may be formed by, for example, cutting a board substrate with a die. Various board thicknesses and materials are acceptable. The stock board may be paper, plastic and/or the like. The stock board may be single ply although, in some instances, it may be desirable for blank 100 to be two or multiple ply. Once blank 100 is formed, it is folded and glued into the package 102 described below. In the description, certain steps are used which help describe the structure of the package 102, but the assembly process may use steps other than these, or in a different order. For example, as described herein, initial assembly may comprise a limited number of folding steps that create a “flattened” tubular structure, which later (and possibly with some folds now made for the first time) is assembled into a “opened” tubular structure.

Certain parts of blank 100 will now be described. The major panels include back panel 110, open spine 120, front panel 130, closed spine 140, and innercell 150. Back panel 110 may comprise a thumb aperture 112. Open spine 120 comprises an aperture that may be partly bounded by support flaps 122. Innercell 150 may comprise an inward stopper wall 152, outward buttress walls 154, floor 156, side beams 157 and top beam 158. Additionally the blank 100 may comprise end panels 134, closure flaps 136, and closure tabs 138.

Package blank 100 may be formed by, for example, cutting a board substrate with a die. Various board thicknesses and materials are acceptable. The stock board may be paper, plastic and/or the like. The stock board may be single ply although, in some instances, it may be desirable for blank 100 to be two or multiple ply. Once blank 100 is formed, it is folded and glued into the package 102 described below.

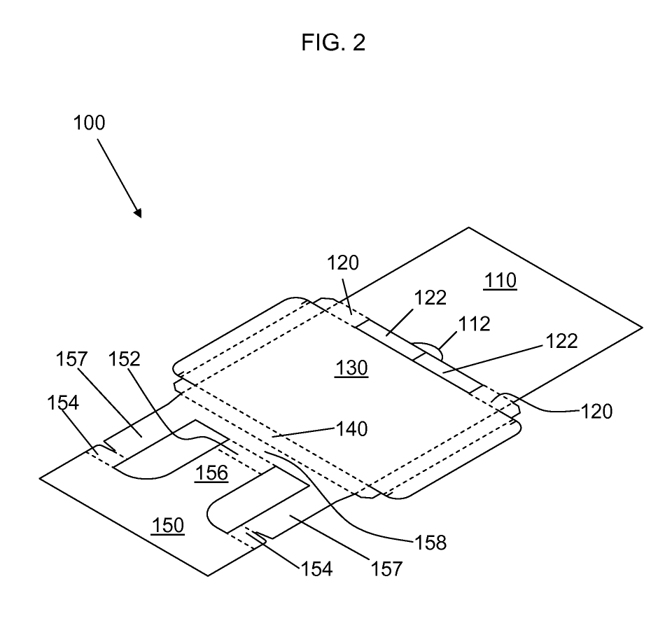

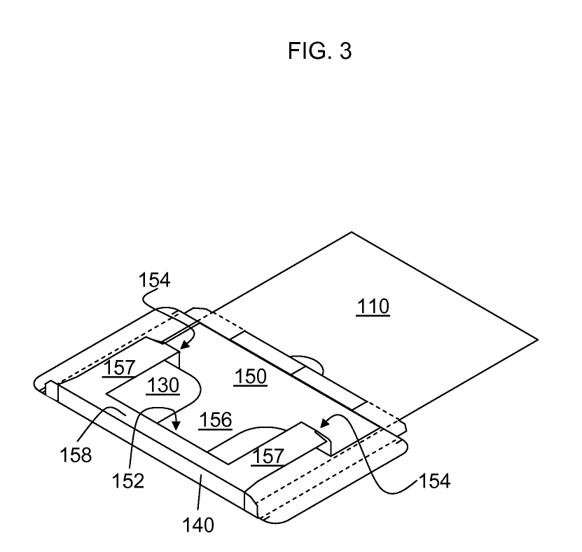

FIG. 2 shows package blank 100 in an isometric view. FIG. 3 shows a step in the forming of blank 100 into a package enclosure 102, for example by a sequence of folding and gluing operations. The sequence shown here is by example only. There may be other sequences also suitable for forming the package enclosure. In FIG. 3, closed spine 140 and innercell 150 have been folded forward relative to front panel 130, and portions of the innercell have been glued to front panel 130. For example, a significant portion of innercell 150, including floor 156, have by folding been brought into parallel contact with front panel 130 to which they may be attached with an adhesive. Other portions including inward stopper wall 152 and outward buttress walls 154 have by folding been made perpendicular to front panel 130, and along with closed spine 140, provide support for side beams 157 and top beam 158, which are now parallel to and spaced apart from front panel 130.

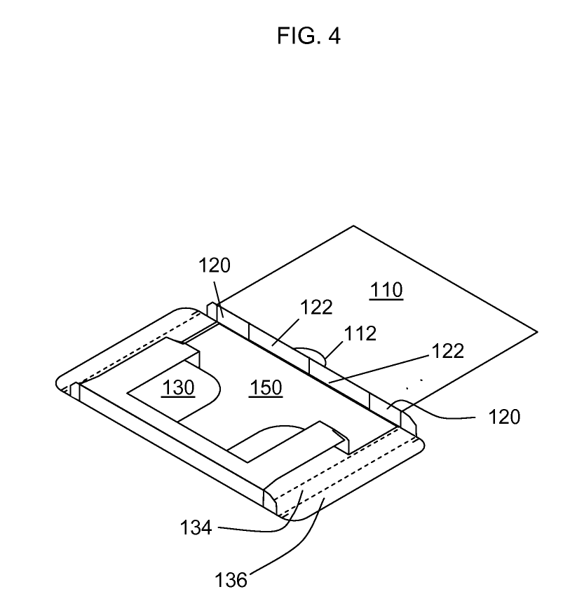

FIG. 4 shows another step in forming the package enclosure, where open spine 120 has been folded upward and is now shown perpendicular to the plane of front panel 130 and innercell 150.

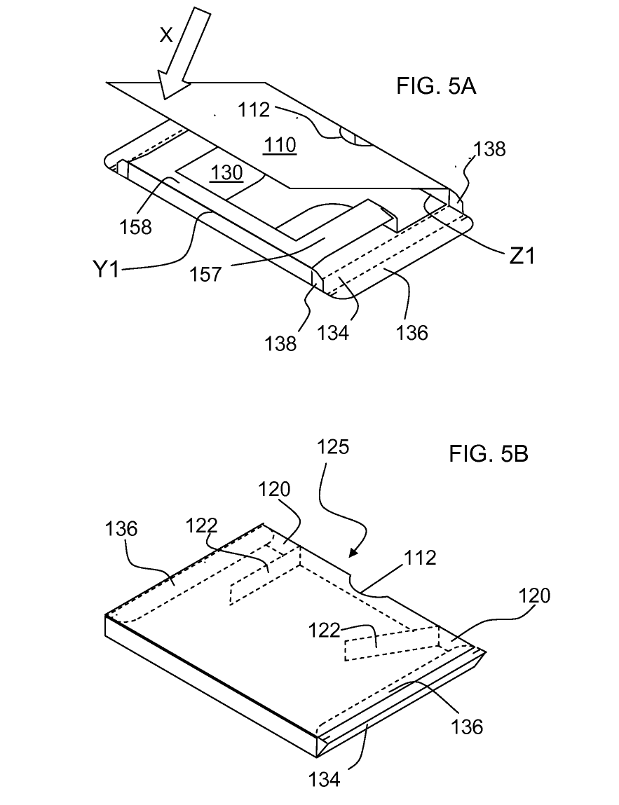

FIG. 5A shows another step in forming the package enclosure, where back panel 110 is folded over upon the package (as denoted by arrow “X”) so that the inside of back panel 110 will rest upon side beams 157 and top beam 158. The back panel 110 is shown partway folded so that the internal structure of the package is still clear. After folding, the inside of back panel 110 may be attached to top beam 158, or side beam 157, or both, for example by use of an adhesive such as glue. The package enclosure thus forms a tubular shape. This tubular shape may be collapsed flat, due in part to end panels 134, closure flaps 136, and closure tabs 138 not yet being folded. In an alternate assembly process, the package enclosure may be formed to a flattened tubular shape by folding only along fold lines Y1 and Z1 (see FIG. 1 and FIG. 5A) and applying adhesive as previously discussed. (Or, by folding only along lines Y2 and Z2) and applying adhesive as previously discussed. Such an assembly (flattened) allows the package to be shipped or handled in a flattened configuration.

FIG. 5B shows a the package in a final assembly step when the tubular assembly (if flattened) is opened into an open tube, the closure tabs 138 (not shown) are folded inward, the end panels 134 have been or are being folded upward, and closure flaps 136 have been or are being folded inward and placed inside the package. Also shown in dotted lines are support flaps 122 being folded inward into the package, where they may form support or guide surfaces for items being inserted into the package. Support flaps 122 may also provide strength to the package. By folding inward support flaps 122, an access opening 125 is created along open spine 120.

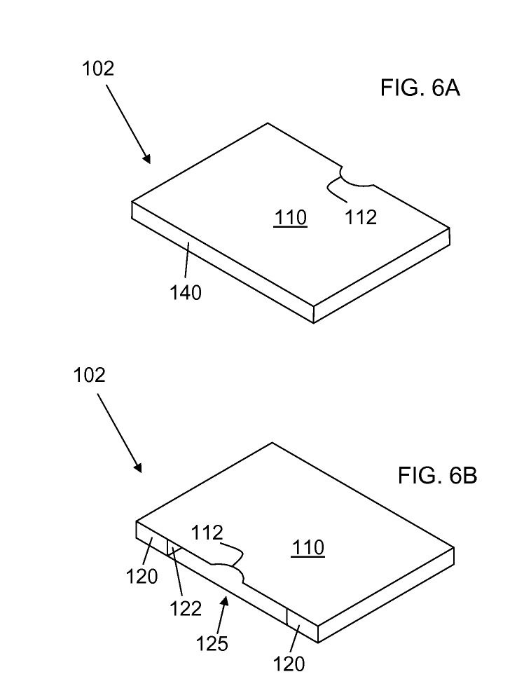

FIG. 6A shows a finished package enclosure. FIG. 6B shows another view of the finished package enclosure 102, with the access opening 125 visible in open spine 120. Items may be inserted into package enclosure 102 through the access opening 125. For example, such items may include disc media.

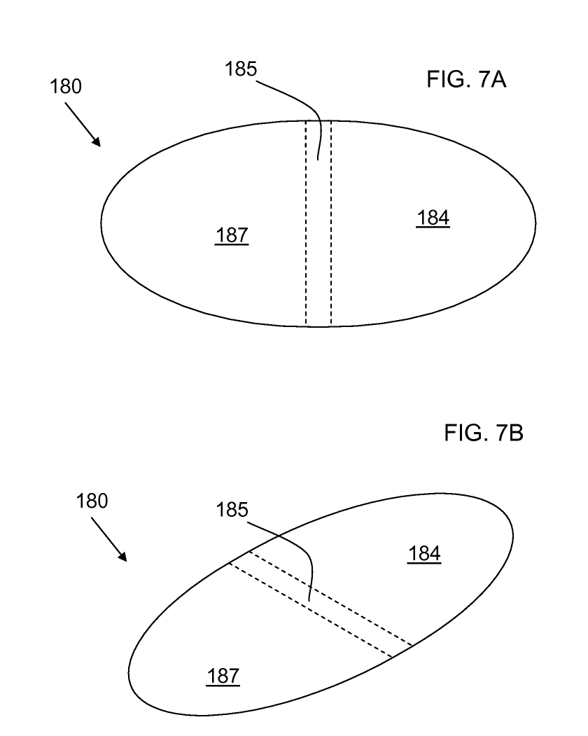

FIG. 7A shows a wrapper blank 180 for forming an exemplary wrapper 182 or “taco” to enclose items, such as disc media, to be held in package enclosure 102. Wrapper blank 180 may comprise a wrapper front panel 184, wrapper spine panel 185, and wrapper back panel 187. FIG. 7B shows wrapper blank 180 in an isometric view.

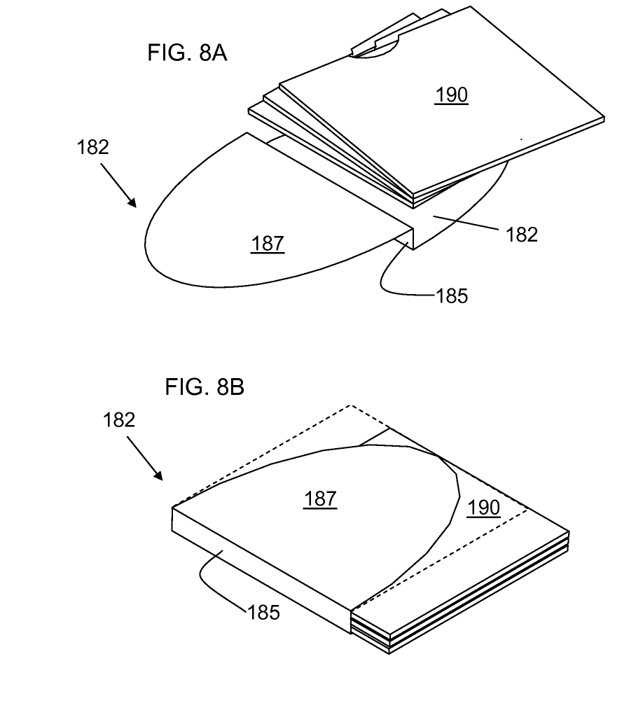

FIG. 8A shows a partly folded wrapper 182 formed from wrapper blank 180. The wrapper 182 may wrap items such as mini-jackets 190, for example containing disc media. In one embodiment, mini-jackets 190 may be formed of sheet material such as paperboard. In FIG. 8A, three mini-jackets are shown, although the number may be more or less.

FIG. 8B shows a fully folded wrapper 182 partly enclosing mini-jackets 190, which for clarity are shown displaced laterally within the folded wrapper 182. In typical use, the mini-jackets 190 would be aligned within wrapper 182 so that one edge of the mini-jackets is more or less abutted against the inside of wrapper spine panel 185, as shown by the dashed line.

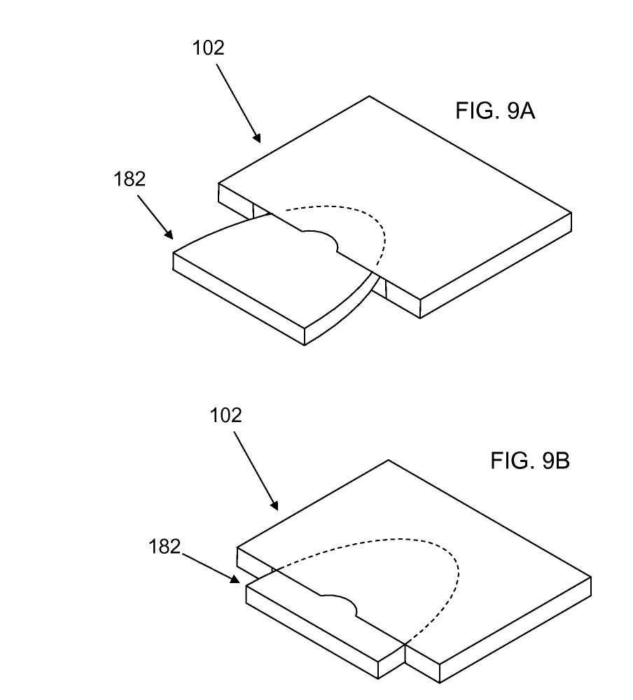

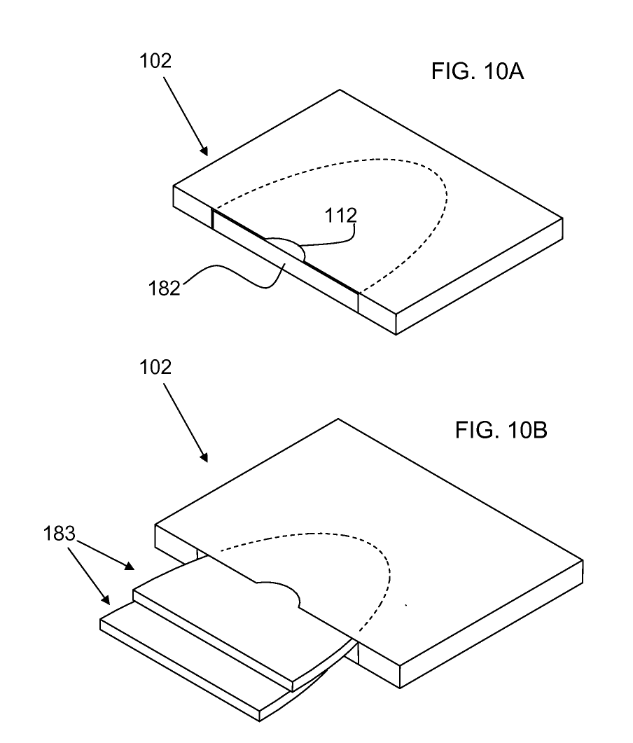

In the remaining FIGURES, mini-jackets 190 are not shown but are understood to be contained within wrapper 182 which is placed within package enclosure 102. FIG. 9A shows wrapper 182 inserted about 30% into package enclosure 102, with a hidden portion of the wrapper shown in a dashed line. FIG. 9B shows wrapper 182 inserted about 80% into package enclosure 102, and FIG. 10A shows wrapper 182 completely inserted into package enclosure 102. Thumb aperture 112 in the package enclosure may be used to provide a grasping point by which to remove wrapper 182 from the package enclosure 102.

Although a single wrapper 182 is shown in the preceding examples, more than one wrapper may be used, for example two wrappers 183 as shown in FIG. 10B. The number of wrappers used may be suitably sized to nest neatly and snugly within package enclosure 102.

In order that the assembled package fit together neatly, the various panels may be suitably sized and shaped. Package blanks 100 and wrapper blank 180 may typically be produced with printing on at least one side. Since these blanks form package enclosure 102 and wrapper 182, respectively, which fit together to form a finished package, blank 180 may be printed so that the graphics on wrapper 182 form a continuous image with the graphics on package enclosure 102 (which were printed on package blank 100).

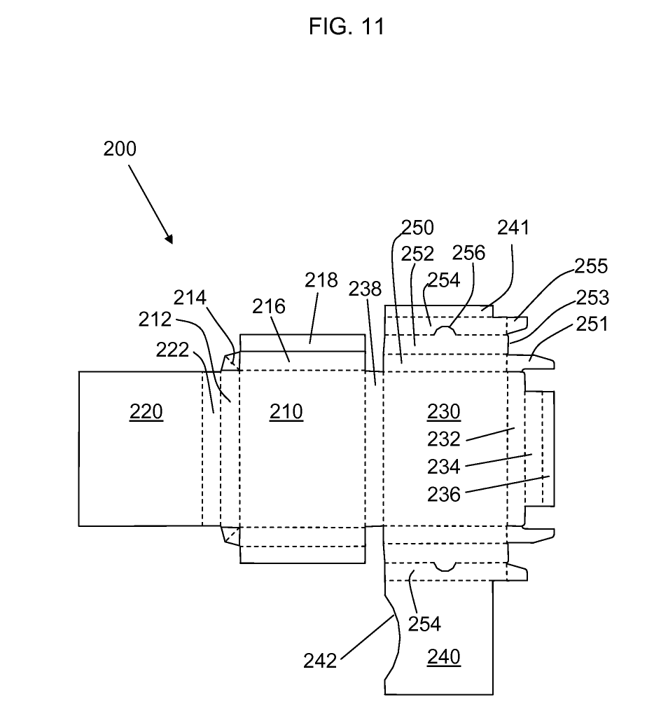

FIG. 11 shows a package blank 200 for forming another exemplary package 202. Package blank 200 may be formed by, for example, cutting a board substrate with a die. Various board thicknesses and materials are acceptable. The stock board may be paper, plastic and/or the like. The stock board may be single ply although, in some instances, it may be desirable for blank 200 to be two or multiple ply. Once blank 200 is formed, it is folded and glued into the package 202 described below.

Certain parts of blank 200 will now be described. Portions of blank 200 are symmetric with respect to the horizontal axis of FIG. 11, and where a given part has been labeled, its mirror-image counterpart is not necessarily labeled. The major panels include front outside panel 210, front inside panel 220, back panel 230, and floor 240. Between the front outside panel 210 and back panel 230 is spine 238. Between front outside panel 210 and front inside panel 220 are outer side panel 212 and inner side panel 222. At each end of front outside panel 210 are an outer end panel 216 and an inner end panel 218. In the flattened blank 200 as shown in FIG. 11, outer end panel 216 is perpendicular to outer side panel 212, with a gusseted dustflap 214 between the juncture of outer end panel 216 and outer side panel 212.

Portions of the blank will form channels 258 as shown later. These portions include channel outer wall 250, channel top wall 252, and channel inner wall 254. The channel inner wall 254 may be connected to back panel 230 by an adhesive attachment through channel foot 241 or floor 240. A semicircular tab 256 may be attached to channel top wall 252. Dust flaps 251 and 255 may are attached to channel outer wall 250 and channel inner wall 254 respectively.

On the side of back panel 230, opposite from spine 238, is outer side wall 232, inner side wall 234, and side wall foot 236. Package blank 200 may be formed by, for example, cutting a board substrate with a die. Various board thicknesses and materials are acceptable. The stock board may be paper, plastic and/or the like. The stock board may be single ply although, in some instances, it may be desirable for blank 200 to be two or multiple ply. Once blank 200 is formed, it is folded and glued into the package 202 described below. For example, the package may be assembled as described herein by the illustrated folding steps, and with blank 200 as viewed in FIG. 11, having adhesive applied to parts or all of inner end panels 218, front inside panel 220, floor 240, and channel foot 241.

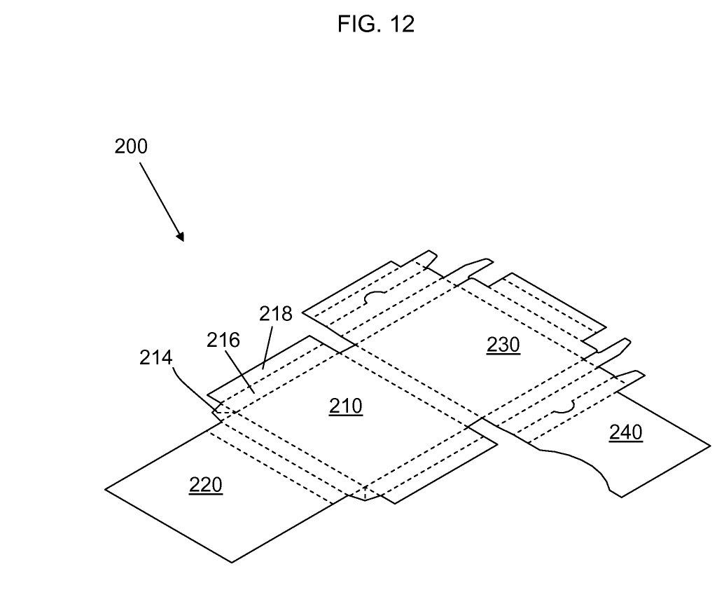

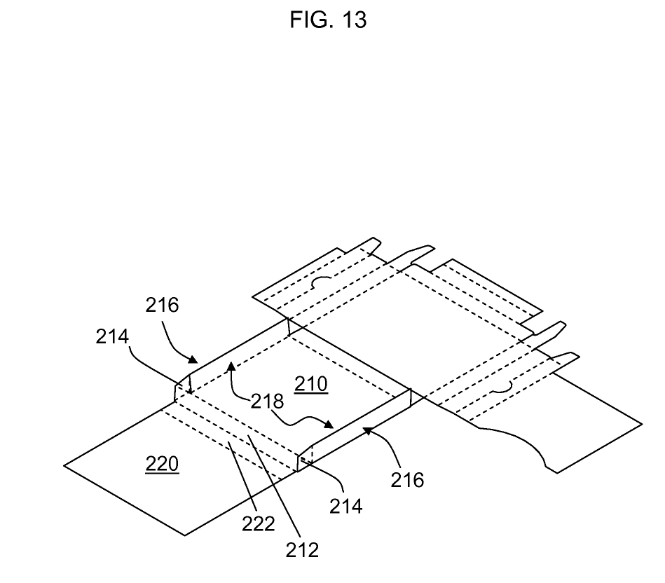

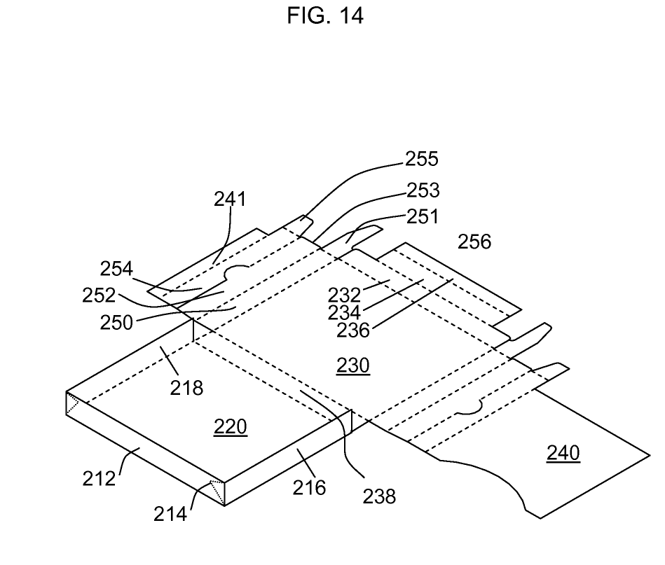

FIG. 12 shows package blank 200 in an isometric view. FIG. 13 shows a step in the forming of blank 200 into a package 202, for example by a sequence of folding and gluing operations. The sequence shown here is by example only. There may be other sequences also suitable for forming the package. In FIG. 13, outer end panels 216 have been folded upward from front outside panel 210, and then inner end panels 218 folded downward relative to outer end panels 216, and adhered thereto, forming upstanding end walls. The gusseted dustflaps 214 will then be folded and tucked between outer side panel 212 and inner side panel 222 in the next step, shown in FIG. 14, where outer side panel 212 is first folded upward relative to front outside panel 210. Inner side panel 222 is then folded back upon outer side panel 212, trapping gusseted dustflaps 214 therebetween as shown by dotted line. Then front inside panel 220 is folded flush onto and adhered to front outside panel 210. This creates a front cover (made of front outside panel 210 and front inside panel 220) bounded by walls on three sides and by spine 238 on the fourth side.

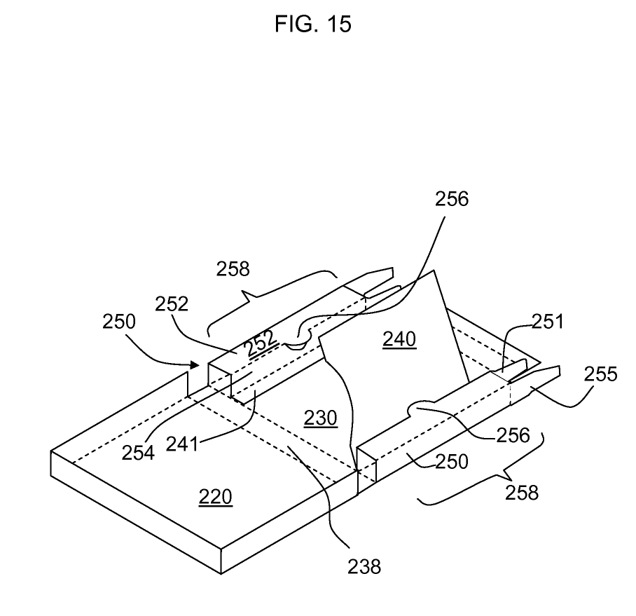

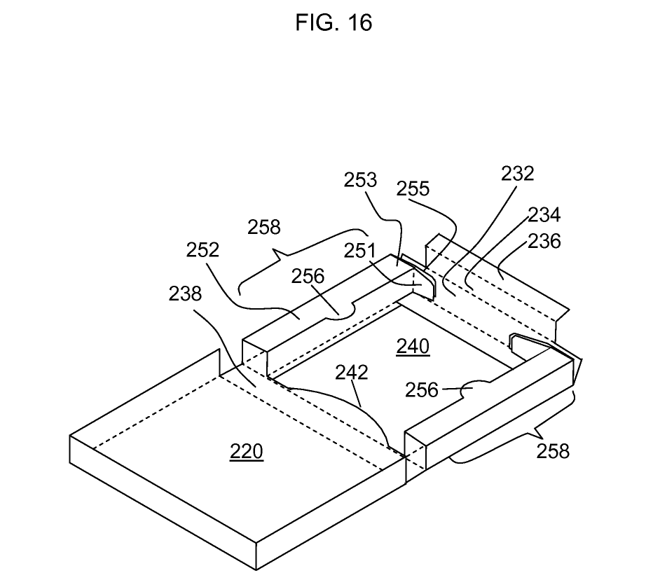

FIG. 15 shows a further step in the forming of the package, where channels 258 are formed, first by folding channel outer wall 250 upward from back panel 230, then folding channel top wall 252 inward, then folding channel inner wall 254 inward and back toward back panel 230. Attached to channel inner wall 254 on one of the channels 258 is channel foot 241 that may be folded relative to channel inner wall 254 and then glued to back panel 230 as shown in final glued position. Attached to channel inner wall 254 on the other of channels 258 is floor 240 that may be folded relative to channel inner wall 254 (this folding process is shown in FIG. 15) and then glued to back panel 230, where it may overlap channel foot 241. On channels 258 thus formed, semicircular tabs 256 protrude inward from channel top walls 252. A dust flap 251 is attached to one end of each channel inner wall 254, and a dust flap 255 is attached to one end of each channel outer wall 250. In the next step, these dust flaps 251 are each folded inward as shown in FIG. 16. Then, from the side of back panel 230 opposite from spine 238, outer side wall 232 may be folded upward from back panel 230. Next, inner side wall 234 may be folded inward from outer side wall 232, trapping dust flaps 251, 255 between outer side wall 232 and inner side wall 234. Finally, side wall foot 236 folded related to inner side wall 234 may be placed in proximity with back panel 230 into a space not covered by floor 240. At least a portion of the end 253 of channel top wall 252 may slightly overlap the tops of the dust flaps 251, 255 which may provide strength to the structure. The folded outer side wall 232 thus fits snugly against the dust flaps 251, 255 and the ends of channels 258, while the folded inner side wall 234 and side wall foot 236 fit snugly between the channels 258.

Package blank 200 may be formed by, for example, cutting a board substrate with a die. Various board thicknesses and materials are acceptable. The stock board m

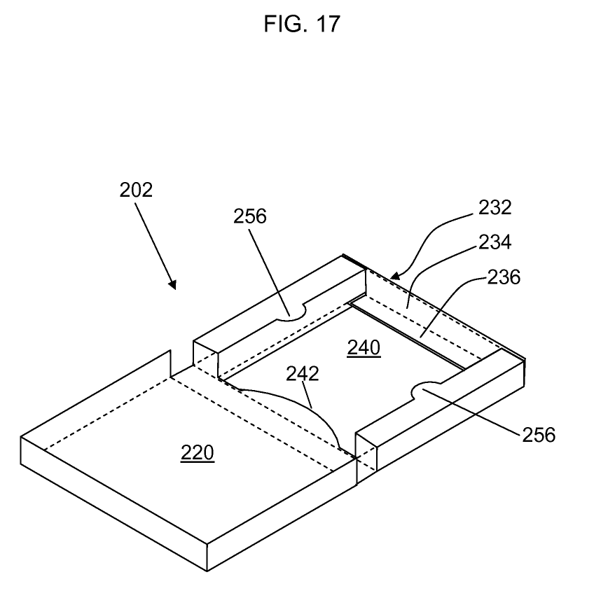

FIG. 17 shows a finished package 202. Floor 240 may have a cutaway area 242. If the glue pattern under floor 240 (holding to back panel 230) is only around the periphery of floor 240 (and not adjacent cutaway area 242, then materials such as a leaflet (not shown) may be inserted between floor 240 and back panel 230.

The finished package 202 may be considered to comprise a cover (generally made up of front outside panel 210, front inside panel 220, and their associated inner and outer end and side panels) and a base (generally made up of back panel 230, floor 240, channels 258, and the associated outer side wall 232 and inner side wall 234). The cover and base are hingedly connected by the spine 238.

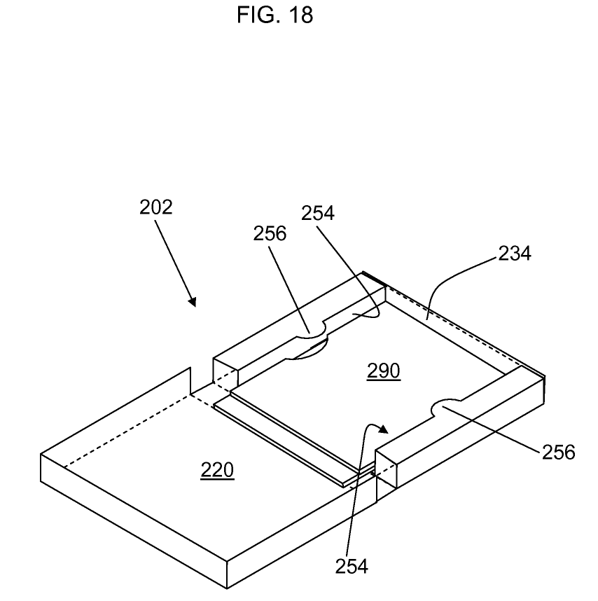

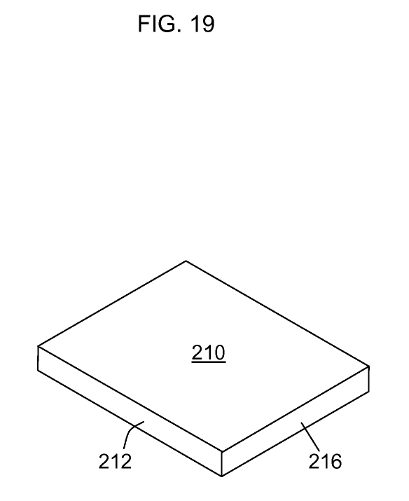

FIG. 18 shows how items 290 may be contained within package 202, between channel 258 and retained by semicircular tabs 256. For example, such items may include slipcases or mini-jackets containing disc media. The items 290 may be placed or slid into package 202, and would normally be positioned with an edge ends abutting inner side wall 234. The items 290 may be closely received between channel inner walls 254. While two items 290 are shown, more or fewer may be held in package 202.

In order that the assembled package fit together neatly, the various panels may be suitably sized and shaped. Package blank 200 may typically be produced with printing on at least one side. Usually the exterior surface of package 202 would be printed. By printing a single surface of blank 200, graphics may be provided on all exterior surfaces of package 202 (that is the major surfaces of front outside panel 210, back panel 230, spine 238, outer side panel 212, and outer end panels 216). By printing the same single surface of blank 200, graphics may also be provided on the inner surfaces of the cover (that is, inside front panel 220, inner side panel 222, and inner end panels 218), as well as the exposed surfaces of channels 258. outer side wall 232 and inner side wall 234, and floor 240. Thus substantially all of the external surfaces of package 202 are printed, and nearly all (even 90% or more) of surfaces internal surfaces that are visible inside an open package are also printed (in the case of package 202, the inside of spine 238 may not be printed. However, by modifying blank 200, even the inside of spine 238 could be printed, for example if an additional narrow panel was provided at the left end (as viewed in FIG. 11) of front inside panel 220.

The package examples shown here are particularly suitable for forming a package sized as is common for a “DVD package,” that is, a package with a major face having one dimensional substantially larger than the other, or a somewhat elongated rectangle as opposed to a generally square shape. The content items as shown by example here have a generally square aspect, as would seen with “mini-jacket” holders for disc media. It will be understood that other blanks may be produced according to the principles of blanks 100 and 180, and blank 200, but with appropriate dimensions to form packages of other sizes and shapes.

The packages disclosed herein may contain one or more items, such as one or more sleeves or mini-jackets containing media discs. For example, the packages may contain from one to 25, or even more, mini-jackets. The term sleeves or mini-jackets is meant to include other forms of thin envelope-type enclosures, such as dust-jackets, sleeves, and the like. The package may contain items other than media discs. In some embodiments the package may be made from paperboard having a thickness of about 0.018″, other types and thicknesses of materials may be utilized as are known in the packaging arts.

The packages can be formed using a variety of materials or substrates. For example, PRINTKOTE EAGLE®, which is composed of at least 10% post consumer recycled material, can be used. Moreover, a polymeric substrate such as calendered POLYLITH® GC-3 can be used. POLYLITH® substrate is manufactured by Nanya Plastics of Taiwan and is distributed in the U.S. by Granwell Products, Inc. POLYLITH® substrate is primarily formed using polypropylene resin and minerals comprising inert calcium carbonate and titanium dioxide and the resulting substrate is strengthened by calendaring.

While the invention has been described with respect to preferred embodiments, those skilled in the art will readily appreciate that various changes and/or modifications can be made to the invention without departing from the spirit or scope of the invention.

1. A package comprising:
i) a rectangular enclosure made of a sheet material, comprising two opposing major faces, the major faces having two longer and two shorter edges,
ii) an enclosure spine section between and joined to the major faces by fold lines along said longer edge;
iii) an access section between the major faces and opposing said enclosure spine section;
wherein the access section comprises an access opening having a width equal to the width of the access section and a length less than the length of the access section;
wherein the access opening is sized to receive at least one item into the rectangular enclosure.

2. The package as recited in claim 1, further comprising at least one internal surface adapted to support said item along a surface parallel to said enclosure spine section.

3. The package as recited in claim 1, further comprising at least one internal surface adapted to support said item along a surface perpendicular to said enclosure spine section.

4. The package as recited in claim 2, wherein said internal surface is spaced apart from the external walls of said rectangular enclosure.

5. The package as recited in claim 1, further comprising a wrapper to at least partially enclose said item as it is received into said rectangular enclosure.

6. The package as recited in claim 5, wherein said wrapper comprises a wrapper spine portion.

7. The package as recited in claim 6, wherein said wrapper spine portion substantially completely fills said access opening when received into said rectangular enclosure.

8. The package as recited in claim 6, wherein said wrapper spine portion when received into said rectangular enclosure comprises graphics forming a continuous image with graphics on the adjacent surfaces outside of said rectangular enclosure.

9. The package as recited in claim 1, wherein at least one of the rectangular enclosure and the wrapper are fabricated from paper board.

10. (canceled)

11. The package as recited in claim 1, wherein the wrapper contains mini-jackets holding optical media.

12. The package as recited in claim 11, wherein the wrapper contains up to about 25 mini-jackets.

13. A package comprising:
iv) a rectangular base defining a volume for receiving one or more items;
v) a spine hingedly attached to the base;
vi) a rectangular cover hingedly attached to the spine and opposite the base;
vii) at least one tubular channel attached to the inside of the base; and
wherein the rectangular cover has four edges, one edge being attached to the spine, and the other three edges comprising upstanding walls; wherein the upstanding walls closely receive the rectangular base when the package is in a closed configuration.

14. The package as recited in claim 13, fabricated from paper board.

15. The package as recited in claim 13, made from a blank printed on one surface, wherein the blank is folded to form the package with printing on substantially all external surfaces, and with printing on the inside of the cover.

16. The package as recited in claim 13, made from a blank printed on one surface, wherein the blank is folded to form the package with printing on substantially all external surfaces, and with printing on the inside of the base.

17. The package as recited in claim 13, made from a blank printed on one surface, wherein the blank is folded to form the package with printing on substantially all external surfaces, and with printing on at least 90% of the surfaces exposed in an open package configuration.

18. The package as recited in claim 13, wherein a tab protrudes from the tubular channel and overhangs the more or more items.

19. The package as recited in claim 13, wherein the package contains one or more optical media.

20. The package as recited in claim 13, wherein the optical media are enclosed in sleeves.

21. The package as recited in claim 3, wherein said internal surface is spaced apart from the external walls of said rectangular enclosure.
